(19) United States
(12) Patent Application Publication
(10) Pub. No.: US 2025/0222624 A1
(43) Pub. Date: Jul. 10, 2025

(54) THERMAL BREAK FOR CONCRETE SLABS

(71) Applicant: Andrew Streling, Spicer, MN (US)

(72) Inventor: Andrew Streling, Spicer, MN (US)

(21) Appl. No.: 19/013,582

(22) Filed: Jan. 8, 2025

Related U.S. Application Data
(60) Provisional application No. 63/618,805, filed on Jan. 8, 2024.

(51) Int. Cl. B28D 1/22; B28D 7/04

(52) U.S. Cl. CPC B28D 1/221; B28D 7/04

(57) ABSTRACT

A thermal break provides a break in thermal conduction between adjacent slabs of concrete. The thermal break can include a form body with a hollow center or core. The body can be an elongated hollow member in the shape of a rectangular tube that is hollow from a first longitudinal end to the opposite longitudinal end. The core can be filled with insulating foam. A plurality of concrete gripping elements such as T-shaped knobs can be provided to the long front and rear sides of the body to grip the concrete slabs adjacent to the respective front and rear sides.

### PRIORITY

This Application claims priority to and the benefit of U.S. Provisional Patent Application No. 63/618,805, filed Jan. 8, 2024, which is incorporated fully herein by reference.

### FIELD

The present invention relates, in general, to the construction of structures with a concrete slab and, more particularly, to a thermal break for concrete slabs where interior and exterior concrete meet.

### BACKGROUND

It is desired, and often required, to provide a thermal break between concrete slabs in the interior of a building or house and any concrete that is located on the exterior of the building or house. The thermal break insulates the interior floor slab from the exterior exposed slab edge. Thermal breaks are beneficial because they help prevent condensation and mold. They reduce heat loss/gain and improve the effective R-value of the building envelope.

There is a need to provide an easy to install thermal break for overhead door, patio door and service door locations.

### SUMMARY

The present invention, in certain embodiments, addresses the drawbacks and weaknesses of the prior art by providing a thermal break to interrupt thermal conduction between adjacent slabs of concrete. The thermal break in certain embodiments can include a form body with a hollow center or core. The body can be an elongated hollow member in the shape of a rectangular tube that is hollow from a first longitudinal end to the opposite longitudinal end. The core can be filled with insulating foam. A plurality of concrete gripping elements such as T-shaped knobs can be provided to the long front and rear sides of the body to grip the concrete slabs adjacent to the respective front and rear sides.

In one example herein, a thermal break comprises an elongated and hollow body, wherein the body is hollow from a first longitudinal end thereof to a second elongated end thereof located opposite the first longitudinal end, each of the first and second longitudinal ends being open into the hollow body as well, the body further including a long front surface spanning between the first and second longitudinal ends and a long rear surface, opposite the long front surface, between the first and second longitudinal ends. A plurality of concrete gripping elements project from one or both of the long front surface and/or the long rear surface. The body is formed of a rigid material with a lower thermal conductivity than concrete.

The hollow body can be filled with insulating material such as a closed cell foam. The rigid material can be a plastic material or fiberglass or a composite material.

Each of the concrete gripping elements can comprise a knob. The knob can comprise an elongated stem and a flat head, wherein the stem extends horizontally outward from the long front surface or long back surface and terminates in the flat head, and wherein the flat head has a wider diameter than the stem. The flat head can be rounded when viewed from the long front surface or the long rear surface. For example, the flat head can be oval shaped when viewed from the long front surface or the long rear surface. In another variation, the knob can be a T-shape rotated ninety degrees clockwise or counterclockwise when viewed from either of the first or second longitudinal end of the body. The concrete gripping elements can be arranged in a plurality of rows and columns on the front and/or rear long surfaces of the body.

In another example herein a thermal break assembly can comprise a first body secured to a second body. The first body is elongated and hollow, wherein the first body is hollow from a first longitudinal end thereof to a second elongated end thereof located opposite the first longitudinal end, each of the first and second longitudinal ends being open into the first body as well, the first body further including a long front surface spanning between the first and second longitudinal ends and a long rear surface, opposite the long front surface, between the first and second longitudinal ends. The second body is elongated and hollow, wherein the second body is hollow from a first longitudinal end thereof to a second elongated end thereof located opposite the first longitudinal end, each of the first and second longitudinal ends being open into the second body as well, the second body further including a long front surface spanning between the first and second longitudinal ends and a long rear surface, opposite the long front surface, between the first and second longitudinal ends. The second body is oriented perpendicular to the first body such that one of the first or second longitudinal ends of the first body contacts one of the long front or rear surfaces of the second body. Each of the first and second bodies are formed of a rigid material with a lower thermal conductivity than concrete.

The second body can be secured to the first body with a plurality of mechanical fasteners such as screws. The second body can be secured to the first body with an adhesive as an alternative to the mechanical fasteners or in addition to the fasteners.

Each of the first and second bodies can comprise a plurality of concrete gripping elements projecting from one or both of the long front surface and/or the long rear surface thereof. Each of the concrete gripping elements can comprise a knob with an elongated stem and a flat head, wherein the stem extends horizontally outward from the long front surface or long back surface and terminates in the flat head, and wherein the flat head has a wider diameter than the stem.

A further example provided herein is a method of providing a thermal break between an interior concrete slab and an exterior concrete slab. The method includes placing an elongated and hollow body atop a foam sheet in a location where the thermal break is desired, wherein the body is hollow from a first longitudinal end thereof to a second elongated end thereof located opposite the first longitudinal end, each of the first and second longitudinal ends being open into the hollow body as well, the body further including a long front surface spanning between the first and second longitudinal ends and a long rear surface, opposite the long front surface, between the first and second longitudinal ends, and wherein the body is formed of a rigid material with a lower thermal conductivity than concrete. The interior and exterior concrete slabs are poured after placing the elongated and hollow body.

The elongated and hollow body can be filled with an insulating material before placing the elongated and hollow body atop the foam sheet. Concrete gripping elements projecting from one or both of the long front surface and/or the long rear surface of the body can be adhered to at least one of the interior concrete slab and the exterior concrete slab.

The above brief summary is not intended to limit the scope of the invention, or describe each embodiment, aspect, implementation, feature or advantage of the invention. The detailed technology and preferred embodiments for the subject invention are described in the following paragraphs accompanying the appended drawings for people skilled in this field to well appreciate the features of the claimed invention. It is understood that the features mentioned hereinbefore and those to be commented on hereinafter may be used not only in the specified combinations, but also in other combinations or in isolation, without departing from the scope of the present invention.

### BRIEF DESCRIPTION OF THE DRAWINGS

FIG. 1 is a side cutaway view of the thermal break in accordance with embodiments of the present invention installed between an interior and an exterior concrete slab.

FIG. 2 is a top plan view of the thermal break in accordance with embodiments of the present invention installed in a building.

FIG. 3 is a side cutaway view of the thermal break in accordance with embodiments of the present invention installed below a service door.

FIG. 4 is an end view of a thermal break in accordance with embodiments of the present invention.

FIG. 5 is a longitudinal side view of a thermal break in accordance with embodiments of the present invention.

FIG. 6 is a perspective view of a longitudinal end portion of a thermal break in accordance with embodiments of the present invention.

FIG. 7 is an end view of a thermal break in accordance with embodiments of the present invention.

FIG. 8 is a perspective view of a thermal break in accordance with embodiments of the present invention.

FIG. 9 is a perspective view of a thermal break between two partial concrete slabs in accordance with embodiments of the present invention.

FIG. 10 is another perspective view of a thermal break between two partial concrete slabs in accordance with embodiments of the present invention.

FIG. 11 is a perspective view of a thermal break being installed adjacent to an overhead door in accordance with embodiments of the present invention.

FIG. 12 is another perspective view of a thermal break being installed adjacent to an overhead door in accordance with embodiments of the present invention.

### DETAILED DESCRIPTION

In the following descriptions, the present invention will be explained with reference to various example embodiments; nevertheless, these embodiments are not intended to limit the present invention to any specific example, environment, application, or particular implementation described herein. Therefore, descriptions of these example embodiments are only provided for purpose of illustration rather than to limit the present invention. The invention is to cover all modifications, equivalents, and alternatives falling within the scope of the invention as defined by the appended claims.

The various features or aspects discussed herein can also be combined in additional combinations and embodiments, whether or not explicitly discussed herein, without departing from the scope of the invention.

Dimensional information provided herein and indicated in the figures is for certain preferred embodiments. It should be recognized, however, that the dimensions, proportions, scale and configurations of components are merely example embodiments and can be varied unless specifically limited in a given claim. Thus, the dimensions, proportions, scale and configurations can be varied without departing from the scope of the invention except where explicitly limited by a given claim.

The thermal break 100 can be used to provide a break in thermal conduction between adjacent slabs of concrete. This is particularly useful where an inside concrete slab meets an outside concrete slab. The thermal break disclosed herein is particularly well suited to be installed where overhead doors and service doors are located on buildings and homes due to its modularity and ease of installation.

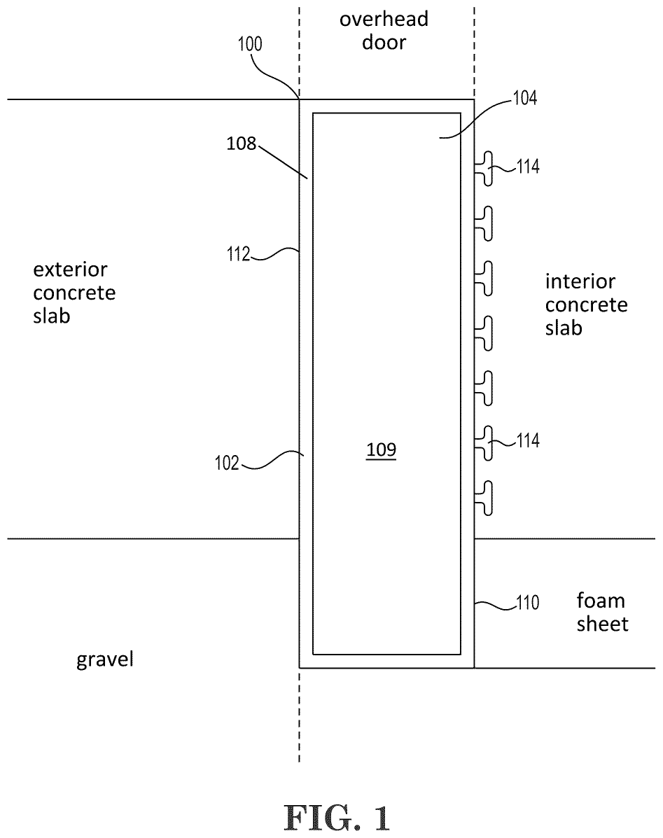

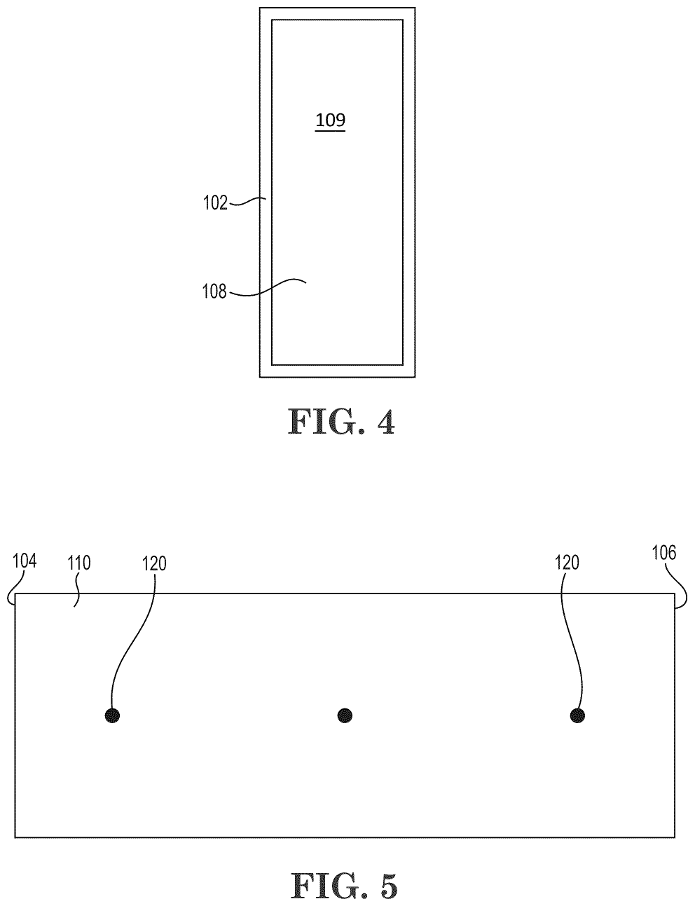

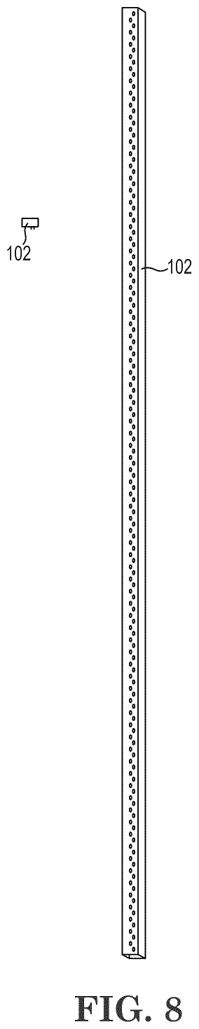

Referring to FIGS. 1-8, the thermal break 100 generally comprises a form body 102 with a hollow center or core 108. The form body 102 comprises an elongated hollow member in the shape of a rectangular tube. The form body 102 is hollow from a first longitudinal end 104 thereof to the opposite second longitudinal end 106 thereof. The first and second ends 104 and 106 are open as well.

The body 102 can be formed of a rigid material such as plastic, fiberglass or composite that does not easily conduct heat like metal does. The use of plastic material allows the form body 102 to be formed via an extrusion process.

The hollow core 108 of the body 102 can be filled with an insulating material such as a closed cell foam 109. The foam increases the insulating value (R-value) of the thermal break 100 and can also add some strength to the body 102.

The long front and/or rear faces 110, 112 of the body 102 spanning between the first and second ends 104, 106 can include one or more concrete gripping elements such as the knobs 114 illustrated in FIGS. 1, 3, 6 and 7. These knobs 114 are generally shaped like a letter T that is rotated ninety degrees clockwise such that they protrude horizontally outward from one or both of the long front and/or rear faces 110, 112.

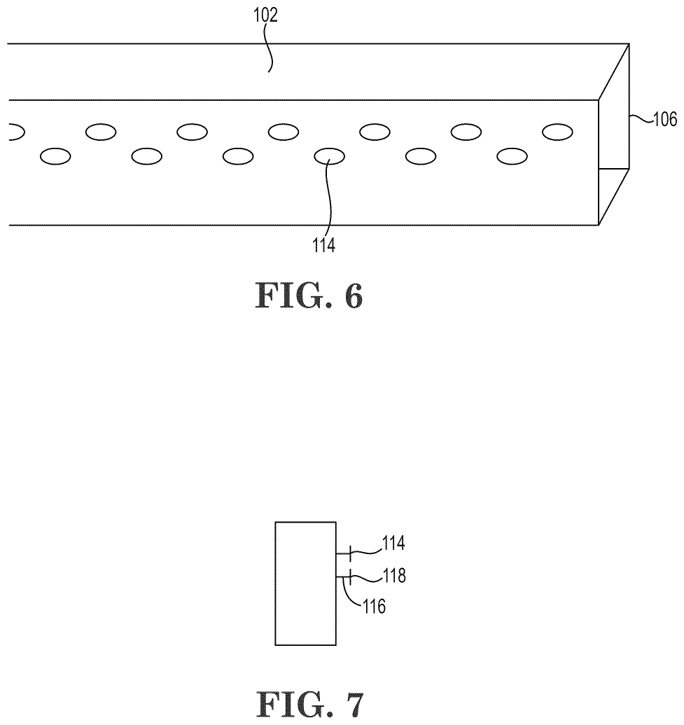

The stem 116 of the T-shape of each knob extends horizontally outward from the front/rear face and terminates in a wide head 118 at the distal end of the stem 116. The head 118 is shown as being oval shaped in FIG. 6. However, the head 118 can be circular shaped, oval shaped, elliptical or other various polygonal shapes when viewed from the front or rear of the body. The size and number of knobs 114 can be varied. The knobs 114 can be formed in rows and columns. The columns and rows can be alternating offset. The size and/or shape of the knobs can also be varied on a given body.

The uncured concrete flows around the head 118 and stem 116 or each knob 114 during the installation process, resulting in the body 102 being locked in place by the concrete once the concrete cures.

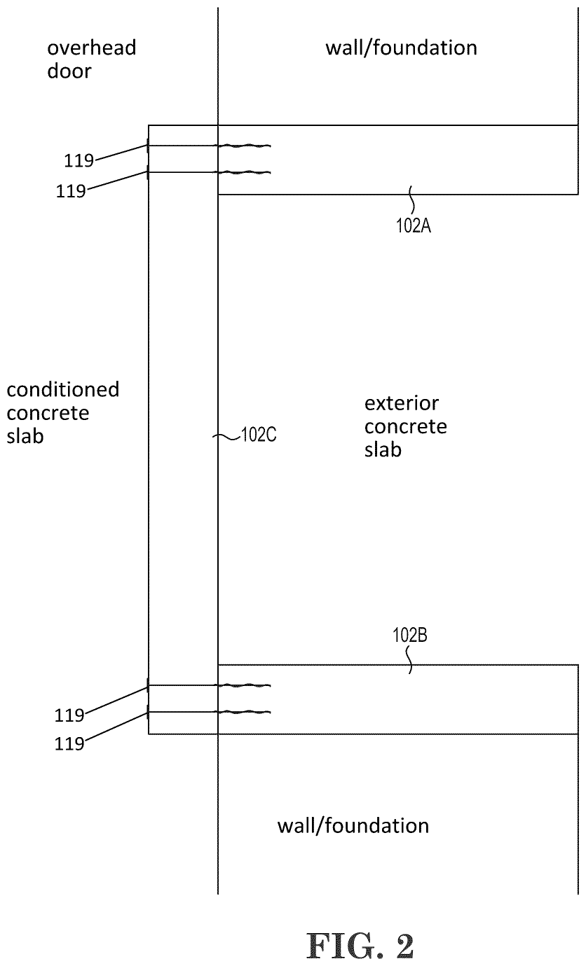

Referring to FIGS. 2-3 and 9-10, it can be seen that multiple bodies 102 of various lengths can be joined together to form a thermal break 100 for a particular installation. For example, as shown in FIG. 2, a squared-off U-shape thermal break in top plan view can be formed from a first and second arm bodies 102A, 102B extending perpendicularly outward from a common front or rear side of a bridge body 102C at the far ends thereof. The arms 102A, 102B can be secured to the bridge body 102C with a plurality of threaded fasteners 119, such as screws, or other type of fastener. Adhesives can be used as well. Moreover, the thermal break could be formed in other desired shapes in other alternative embodiments.

FIG. 2 illustrates a thermal break configuration particularly useful for an installation having an overhead door. This thermal break arrangement is shown in top plan view.

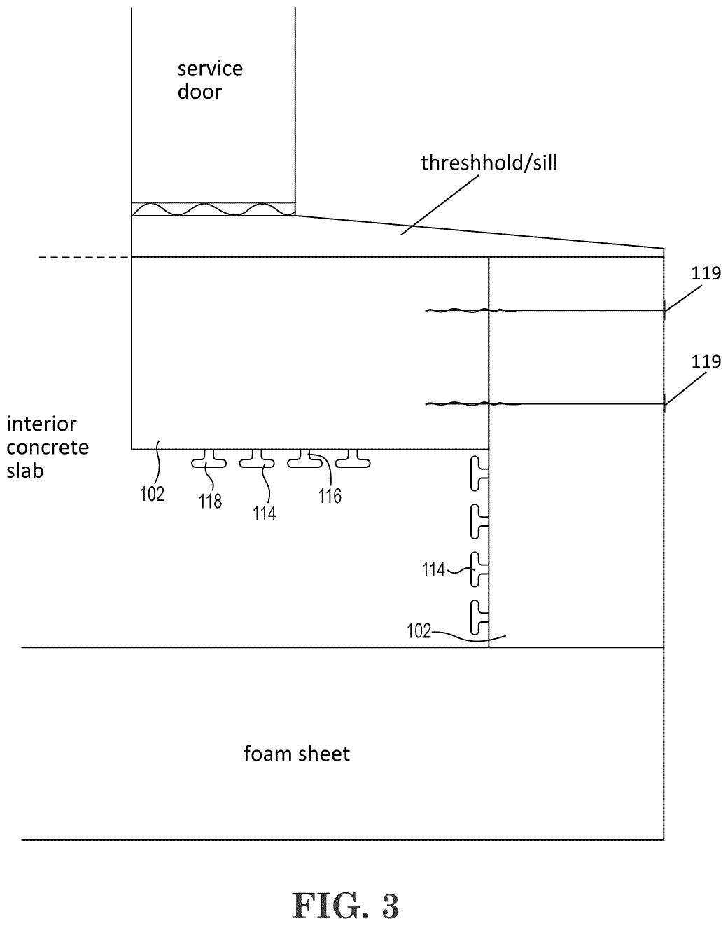

FIG. 3 illustrates a thermal break configuration particularly useful for an installation having a service door. This thermal break arrangement is shown in a side cross-sectional view.

FIG. 5 illustrates an alternative embodiment to using knobs 114 as concrete gripping elements. Instead, in this embodiment, a plurality of fiberglass pins 120 are inserted through the front-to-back width of the body 102 (perpendicular to the longitudinal or long axis of the body 102) so that the pins 120 protrude perpendicularly from the front and rear sides of the body 102.

The body 102 can be formed in any desired length. The body 102 can also be cut to a desired length with a saw.

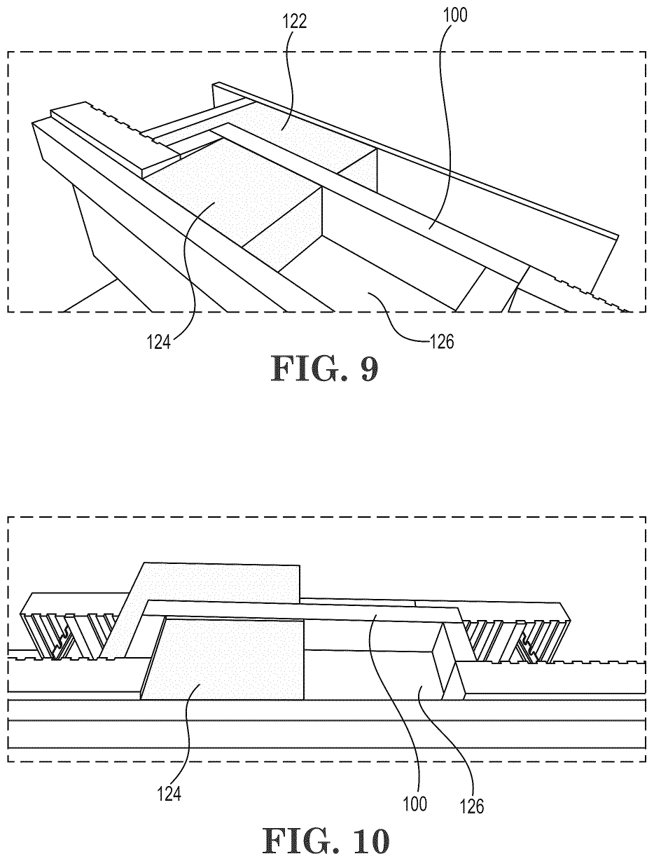

FIGS. 9 and 10 illustrate the installation of a thermal break 100 relative to inside and outside concrete slabs 122, 124. It can also be seen that the thermal break 100 and interior slab sit on top of a polystyrene board or sheet 126. The knobs 114 are not shown on the bodies 102 in these figures but can be provided as discussed herein above.

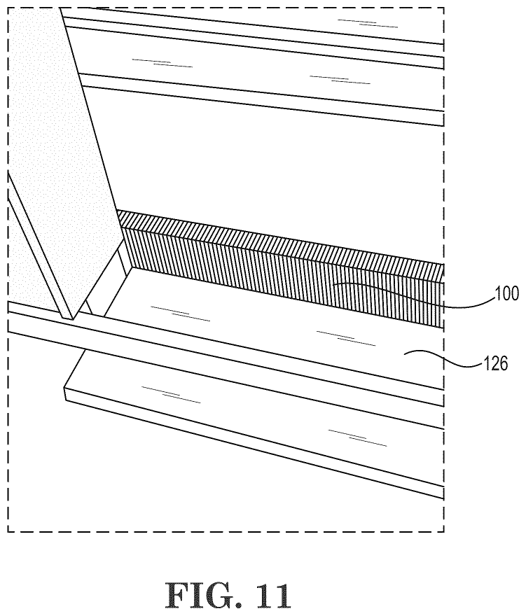

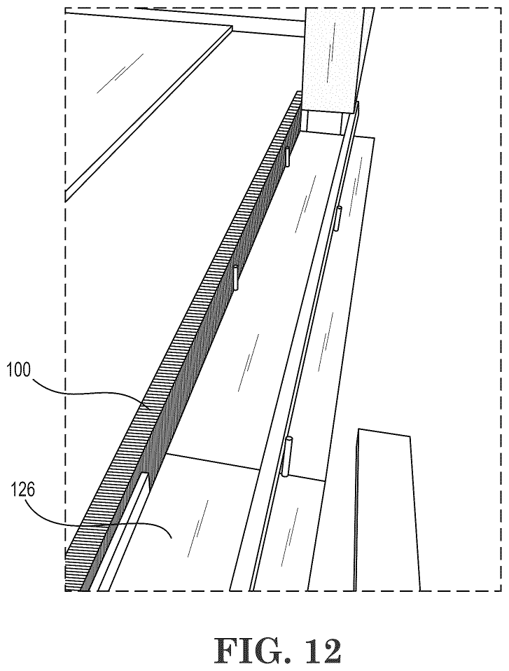

FIGS. 11-12 illustrate a thermal break 100 installed as a single linear body along the inside of a threshold for an overhead door. Again, an underlying polystyrene sheet 126 is provided. The knobs 114 are not shown on the body 102 in these figures but can be provided as discussed herein above.

In use, thermal break is first assembled if it is to be a multi-body configuration. Each body is filled with foam as desired and cut to length. The bodies are fastened together to form the thermal break construct as desired for the particular application. Then the thermal break is placed in its desired location prior to pouring the adjacent concrete slabs. The concrete slabs are then poured.

While the invention has been described in connection with what is presently considered to be the most practical and preferred example embodiments, it will be apparent to those of ordinary skill in the art that the invention is not to be limited to the disclosed example embodiments. It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products.

For purposes of interpreting the claims for the present invention, it is expressly intended that the provisions of Section 112, sixth paragraph of 35 U.S.C. are not to be invoked unless the specific terms “means for” or “step for” are recited in a claim.

What is claimed is:

1. A thermal break, comprising:
an elongated and hollow body, wherein the body is hollow from a first longitudinal end thereof to a second elongated end thereof located opposite the first longitudinal end, each of the first and second longitudinal ends being open into the hollow body as well, the body further including a long front surface spanning between the first and second longitudinal ends and a long rear surface, opposite the long front surface, between the first and second longitudinal ends,
wherein a plurality of concrete gripping elements project from one or both of the long front surface and/or the long rear surface, and
wherein the body is formed of a rigid material with a lower thermal conductivity than concrete.

2. The thermal break of claim 1, wherein the hollow body is filled with insulating material.

3. The thermal break of claim 2, wherein the insulating material is a closed cell foam.

4. The thermal break of claim 1, wherein the rigid material is a plastic material.

5. The thermal break of claim 1, wherein the rigid material is fiberglass.

6. The thermal break of claim 1, wherein each of the concrete gripping elements comprises a knob.

7. The thermal break of claim 6, wherein the knob comprises an elongated stem and a flat head, wherein the stem extends horizontally outward from the long front surface or long back surface and terminates in the flat head, and wherein the flat head has a wider diameter than the stem.

8. The thermal break of claim 7, wherein the flat head is rounded when viewed from the long front surface or the long rear surface.

9. The thermal break of claim 7, wherein the flat head is oval shaped when viewed from the long front surface or the long rear surface.

10. The thermal break of claim 6, wherein the knob has a T-shape rotated ninety degrees clockwise or counterclockwise when viewed from either of the first or second longitudinal end of the body.

11. The thermal break of claim 1, wherein the concrete gripping elements are arranged in a plurality of rows and columns on the front and/or rear long surfaces of the body.

12. A thermal break assembly, comprising:
a first body that is elongated and hollow, wherein the first body is hollow from a first longitudinal end thereof to a second elongated end thereof located opposite the first longitudinal end, each of the first and second longitudinal ends being open into the first body as well, the first body further including a long front surface spanning between the first and second longitudinal ends and a long rear surface, opposite the long front surface, between the first and second longitudinal ends; and
a second body that is elongated and hollow, wherein the second body is hollow from a first longitudinal end thereof to a second elongated end thereof located opposite the first longitudinal end, each of the first and second longitudinal ends being open into the second body as well, the second body further including a long front surface spanning between the first and second longitudinal ends and a long rear surface, opposite the long front surface, between the first and second longitudinal ends,
wherein the second body is oriented perpendicular to the first body such that one of the first or second longitudinal ends of the first body contacts one of the long front or rear surfaces of the second body,
wherein the second body is secured to the first body, and
wherein each of the first and second bodies are formed of a rigid material with a lower thermal conductivity than concrete.

13. The thermal break assembly of claim 12, wherein the second body is secured to the first body with a plurality of mechanical fasteners.

14. The thermal break assembly of claim 13, wherein the mechanical fasteners are screws.

15. The thermal break assembly of claim 12, wherein the second body is secured to the first body with an adhesive.

16. The thermal break assembly of claim 12, wherein each of the first and second bodies comprises a plurality of concrete gripping elements projecting from the long front surface and/or the long rear surface thereof.

17. The thermal break assembly of claim 16, wherein each of the concrete gripping elements comprises a knob with an elongated stem and a flat head, wherein the stem extends horizontally outward from the long front surface or long back surface and terminates in the flat head, and wherein the flat head has a wider diameter than the stem.

18. A method of providing a thermal break between an interior concrete slab and an exterior concrete slab, the method comprising:
placing an elongated and hollow body atop a foam sheet in a location where the thermal break is desired, wherein the body is hollow from a first longitudinal end thereof to a second elongated end thereof located opposite the first longitudinal end, each of the first and second longitudinal ends being open into the hollow body as well, the body further including a long front surface spanning between the first and second longitudinal ends and a long rear surface, opposite the long front surface, between the first and second longitudinal ends, and wherein the body is formed of a rigid material with a lower thermal conductivity than concrete;
pouring the interior concrete slab after placing the elongated and hollow body; and
pouring the exterior concrete slab after placing the elongated and hollow body.

19. The method of claim 18, further comprising filling the elongated and hollow body with an insulating material before placing the elongated and hollow body atop the foam sheet.

20. The method of claim 18, further comprising adhering concrete gripping elements projecting from one or both of the long front surface and/or the long rear surface of the body to at least one of the interior concrete slab and the exterior concrete slab.
